(19) United States
(12) Patent Application Publication
(10) Pub. No.: US 2020/0228898 A1
(43) Pub. Date: Jul. 16, 2020

(54) PHASE-SHIFTING ACTUATOR DRIVING SIGNALS AND PANEL AUDIO LOUDSPEAKERS USING THE SAME

(71) Applicant: Google LLC, Mountain View, CA (US)

(72) Inventors: Mark William Starnes, Sunnyvale, CA (US); James East, San Jose, CA (US)

(21) Appl. No.: 16/247,477

(22) Filed: Jan. 14, 2019

(51) Int. Cl. H04R 3/04; H04R 7/04

(52) U.S. Cl. CPC H04R 3/04; H04R 2499/11; H04R 7/045

(57) ABSTRACT

A panel audio loudspeaker includes a panel, a first actuator, a second actuator, and an electronic control module. The first actuator is attached to the panel at a first location and configured to vibrate the panel at the first location based on a first signal having a first phase. The second actuator is attached to the panel at a second location different from the first location and is configured to vibrate the panel at the second location based on a second signal having a second phase. The electronic control module is programmed to provide the first and second signals to the first and second actuators. During operation, the vibrations from the first and second actuators cause the panel to generate an audio response and the electronic control module varies the first phase relative to the second phase according to the frequency of the audio response.

### BACKGROUND

Many conventional loudspeakers produce sound by inducing piston-like motion in a diaphragm. Panel audio loudspeakers, such as distributed mode loudspeakers (DMLs), in contrast, operate by inducing uniformly distributed vibration modes in a panel through an electro-acoustic actuator. Typically, the actuators are electromagnetic or piezoelectric actuators.

The vibration of the DML's actuators is timed so as to drive the panel of the DML at a range of frequencies of vibration. DMLs that include multiple actuators may display decreased efficiency when output audio within certain frequency ranges as a result of one or more actuators destructively interfering with the vibration modes of the panel.

### SUMMARY

Disclosed are improvements to conventional panel-actuator systems. For example, implementations of the subject matter feature panel audio loudspeakers including electronic control modules, which can determine whether a desired output audio frequency of the loudspeaker would lead an actuator to destructively interfere with the vibration of the panel, therefore causing inefficient power transfer to the panel. The electronic control module can phase-shift an actuator driving signal to improve the power transfer efficiency of the panel-actuator system.

In general, in a first aspect, the invention features a panel audio loudspeaker that includes a panel. The panel audio loudspeaker also includes a first actuator attached to the panel at a first location and configured to vibrate the panel at the first location based on a first signal having a first frequency, a first phase, and a first amplitude. The panel audio loudspeaker further includes a second actuator attached to the panel at a second location different from the first location. The second actuator is configured to vibrate the panel at the second location based on a second signal having a second frequency, a second phase, and a second amplitude. The panel audio loudspeaker also includes an electronic control module in communication with the first and second actuators. The electronic control module is programmed to provide the first and second signals to the first and second actuators. During operation, the vibrations from the first and second actuators cause the panel to generate an audio response and the electronic control module varies the first phase relative to the second phase according to the frequency of the audio response.

Embodiments of the panel audio loudspeaker can include one or more of the following features and/or one or more features of other aspects. For example, the first and second frequencies can be the same.

In some embodiments, the frequency of the audio response is in a range from about 300 Hz to about 800 Hz and a phase difference between the first and second signals is 180 degrees or less. In other embodiments, the frequency of the audio response is in a range from about 1,000 Hz to about 2,000 Hz and a phase difference between the first and second signals is 180 degrees or more.

In some embodiments, at least one of the first and second actuators is an electromagnetic actuator. In other embodiments, at least one of the first and second actuators is a distributed mode actuator. In yet other embodiments, at least one of the first and second actuators is a direct drive piezoelectric actuator.

In some embodiments, the panel audio loudspeaker includes at least one additional actuator attached to the panel at a location different from the first and second locations. The at least one additional actuator can be configured to vibrate the panel at the attachment location based on a corresponding signal having a corresponding frequency, a corresponding phase, and a corresponding amplitude. The electronic control module can be programmed to provide the at least one additional actuator with the corresponding signal and to vary the phase of the corresponding signal with respect to the first and second phases according to the frequency of the audio response.

In some embodiments, during operation, the electronic control module varies the first amplitude relative to the second amplitude according to the frequency of the audio response.

In some embodiments, an efficiency of the panel audio loudspeaker at the audio frequency is greater for a non-zero phase difference between the first and second signals than when the phase difference is zero.

In some embodiments, the electronic control module includes a memory module that includes data relating each of a plurality of different frequencies for the audio response to a corresponding phase difference for the first and second signals.

In some embodiments, the panel includes a display. The display can be an OLED display. In some embodiments, the display includes a touch panel.

In another aspect, a method includes providing a panel audio loudspeaker that includes a panel and first and second actuators attached to the panel at different locations. The method further includes driving the panel audio loudspeaker to provide an audio response by simultaneously driving the first and second actuators with respective first and second signals. The method also includes varying a phase difference between the first and second signals according to a frequency of the audio response.

In some embodiments, the phase is varied to increase an efficiency of the panel audio loudspeaker compared to an efficiency of the panel audio loudspeaker when the first and second signals have the same phase.

In some embodiments, the method further includes varying a relative amplitude between the first and second signals according to a frequency of the audio response.

In another aspect, a mobile device includes an electronic display panel extending in a plane. The mobile device also includes a chassis attached to the electronic display panel and defining a space between a back panel of the chassis and the electronic display panel. The mobile device further includes an electronic control module housed in the space, and the electronic control module includes a processor. The mobile device also includes a first actuator housed in the space and attached to the electronic display panel at a first location and configured to vibrate the electronic display panel at the first location based on a first signal having a first frequency, a first phase, and a first amplitude. The mobile device also includes a second actuator housed in the space and attached to the electronic display panel at a second location different from the first location. The second actuator is configured to vibrate the electronic display panel at the second location based on a second signal having a second frequency, a second phase, and a second amplitude. The electronic control module can be in electrical communication with the first and second actuators and programmed to activate the first and second actuators during operation of the mobile device to generate an audio response and vary the first phase relative to the second phase according to a frequency of the audio response.

Among other advantages, embodiments feature mobile devices having DMLs that are able to vary the phase difference between driving signals for actuators of the DMLs. Varying the phase difference between the driving signals allows the mobile device to increase acoustic power output for audio frequency ranges that would otherwise suffer from one or more actuators destructively interfering with the vibration of the panel. By introducing a phase-difference between driving signals, a mobile device can achieve a greater acoustic power output within certain audio frequency ranges without requiring a current with a magnitude greater than driving signals that are not phase-shifted. As another advantage, it is possible to drive an actuator with a phase-shifted signal having a lower current than that of a non-phase-shifted signal, while maintaining the same acoustic power output.

Phase-shifting signals can also be used to increase privacy, e.g., by selectively minimizing or maximizing sound pressure level output in a far-field or near-field mode. For example, a phase difference can be chosen that ensures a minimum far-field sound pressure level so that only a user within a threshold distance to the mobile device can hear the audio output by the device.

Other advantages will be evident from the description, drawings, and claims.

### BRIEF DESCRIPTION OF THE DRAWINGS

FIG. 1 is a perspective view of an embodiment of a mobile device.

FIG. 2 is a schematic cross-sectional view of the mobile device of FIG. 1 featuring a panel audio loudspeaker that includes a panel and two actuator.

FIG. 3 is a schematic cross-sectional view of the mobile device shown in FIG. 1, with points of interest on the panel and actuators labeled.

FIG. 4A is cross-sectional view of a mobile device featuring a panel audio loudspeaker that includes a pair of electromagnetic actuators.

FIG. 4B is cross-sectional view of a mobile device featuring a panel audio loudspeaker that includes a pair of distributed mode actuators.

FIG. 4C is cross-sectional view of a mobile device featuring a panel audio loudspeaker that includes a direct-drive piezoelectric actuator.

FIG. 5 is a top view of a display panel of a mobile device with locations marked on the panel where actuators are placed.

FIG. 6 is a plot showing acoustic power output by the panel of FIG. 5 versus audio output frequency.

FIG. 7 is a schematic diagram of an embodiment of an electronic control module for a mobile device.

Like reference symbols in the various drawings indicate like elements.

### DETAILED DESCRIPTION

The disclosure features actuators for panel audio loudspeakers, such as distributed mode loudspeakers (DMLs). Such loudspeakers can be integrated into a mobile device, such as a mobile phone. For example, referring to FIG. 1, a mobile device 100 includes a device chassis 102 and a panel 104 including a touch-sensitive flat panel display (e.g., an OLED or LCD display panel) that integrates a panel audio loudspeaker. Mobile device 100 interfaces with a user in a variety of ways, including by displaying images and receiving touch input via panel 104. Typically, a mobile device has a depth (in the z-direction) of approximately 10 mm or less, a width (in the x-direction) of 60 mm to 80 mm (e.g., 68 mm to 72 mm), and a height (in the y-direction) of 100 mm to 160 mm (e.g., 138 mm to 144 mm).

Mobile device 100 also produces audio output. The audio output is generated using the panel audio loudspeaker that creates sound by causing the flat panel display to vibrate. Panel 104 is coupled to two or more actuators, such as distributed mode actuators, or DMAs. The one or more actuators are movable components arranged to provide a force to a panel, such as panel 104, causing the panel to vibrate. The vibrating panel generates human-audible sound waves, e.g., in the range of 20 Hz to 20 kHz.

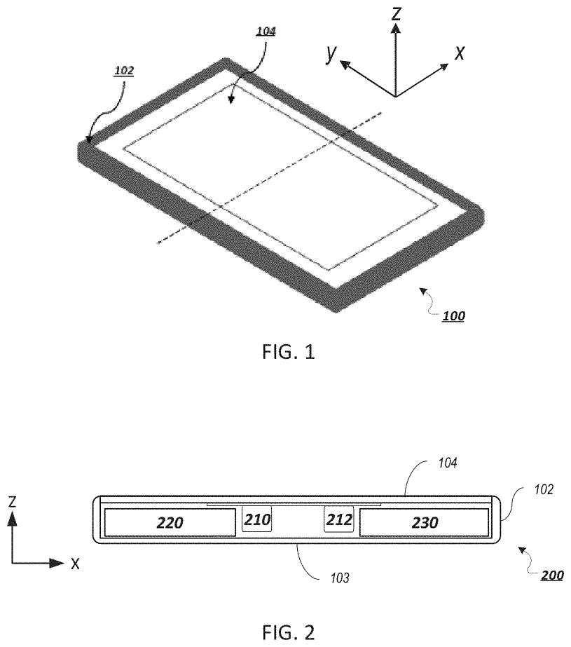

Referring also to FIG. 2, which shows a cross-section of mobile device 100, a chassis 102 has a back panel 103, which extends primarily in the xy-plane. Mobile device 100 also includes two actuators 210 and 212, which are housed behind panel 104 in chassis 102 and affixed to the back side of panel 104. Generally, actuators 210 and 212 are sized to fit within a volume constrained by other components housed in the chassis, including an electronic control module 220 and a battery 230.

Electronic control module 220 controls the operation of actuators 210 and 212 independently from one another. Because the actuators are independently controllable, each actuator can vibrate in response to a different control signal having variable properties e.g., frequency, amplitude, or phase. For example, actuator 210 can vibrate at a first frequency, amplitude, and phase, while actuator 212 can vibrate a second, different frequency, amplitude, and phase.

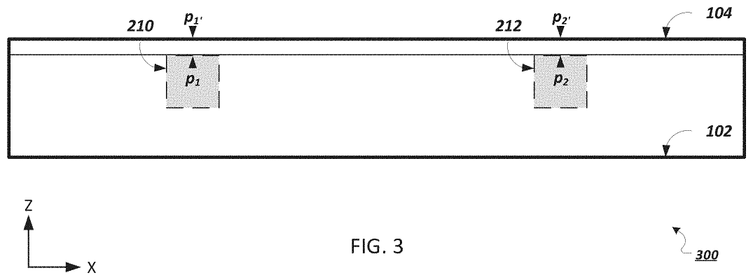

Referring to FIG. 3, actuators 210 and 212 drive panel 104 to vibrate by displacing a corresponding point on panel 104 in the z-direction. For example, FIG. 3 shows points p₁ and p₂ on the actuators 210 and 212, respectively. FIG. 3 also shows corresponding points p_{1′} and p_{2′} on panel 104, to which the corresponding actuators are coupled. Points p₁ and p_{1′} form a first line that is parallel to the z-axis, while points p₂ and p_{2′} form a second line that is also parallel to the z-axis. Generally, the actuators drive panel 104 to vibrate by displacing at least a component of the actuator in the z-direction. This component is coupled to the corresponding point on the panel, which is similarly displaced. An actuator is said to be in phase with the panel when the velocity of the moving actuator component is approximately equal to the velocity of the corresponding point on the panel.

Accordingly, when actuator 210 is in phase with panel 104, the vibration of the actuator in the z-direction displaces point p₁ at a velocity that is approximately equal to the velocity experienced by the panel at point p_{1′}, which is caused by the vibration of the panel. Similarly, when actuator 212 is in phase with panel 104, the vibration of the actuator in the z-direction displaces point p₂ at a velocity that is approximately equal to the velocity experienced by the panel at point p_{2′}. In general, the panel-actuator system is most efficient when both actuators are in phase with the corresponding point on panel 104 because in these conditions the actuator transfers maximum power to the panel.

At certain frequencies of vibration, the panel-actuator system may no longer be in phase. For example, when actuators 210 and 212 drive the panel at certain frequencies of vibration, the velocities of point p_{1′} or p_{2′} may differ from the velocities of point p₁ or p₂, e.g., in magnitude, direction, or both. In this case, the vibration of the actuator interferes with the vibration of the panel, which causes the panel to vibrate at a frequency other than the driving frequency imposed by electronic control module 220. That is, a location on the panel at which an actuator is attached can vibrate at a different velocity than the velocity of vibration of the actuator. The panel-actuator system being out of phase generally results in inefficient power transfer to the panel.

Accordingly, electronic control module 220 can vary a phase difference between the signals driving actuators 210 and 212, especially at frequencies of vibration at which the panel-actuator system would be out of phase and/or at which the power output of panel 104 would be increased as a result of the phase-shifting. For example, if at a certain frequency, actuators 210 and 212 are in phase with each other but out of phase with panel 104, electronic control module 220 can phase-shift the driving signal of either actuator such that the actuators are out of phase with each other but in phase with the panel.

By varying the phase difference of the driving signals, the efficiency of a panel audio loudspeaker at particular audio frequencies can be increased relative to the efficiency of the same loudspeaker driven by signals that are always in phase. Accordingly, by introducing a phase difference at at least some frequencies, panel 104 can achieve a greater acoustic power output from the loudspeaker without increasing a current supplied to actuators 210 and 212. As another example, panel 104 can achieve the same acoustic power output using a driving signal with a lower current than would be necessary if the actuators were driven in phase.

Generally, the phase difference between the two drive signals can vary for different audio response frequencies. For example, at certain frequencies or ranges of frequencies, the phase difference between the drive signals can be zero, while at other frequencies or ranges of frequencies, the phase difference can be up to 180 degrees. Intermediate phase differences can also be used. For example, at a given frequency or range of frequencies, the phase difference can be about 10 degrees or more (e.g., about 30 degrees or more, about 60 degrees or more, about 90 degrees or more, about 120 degrees or more, about 150 degrees or more).

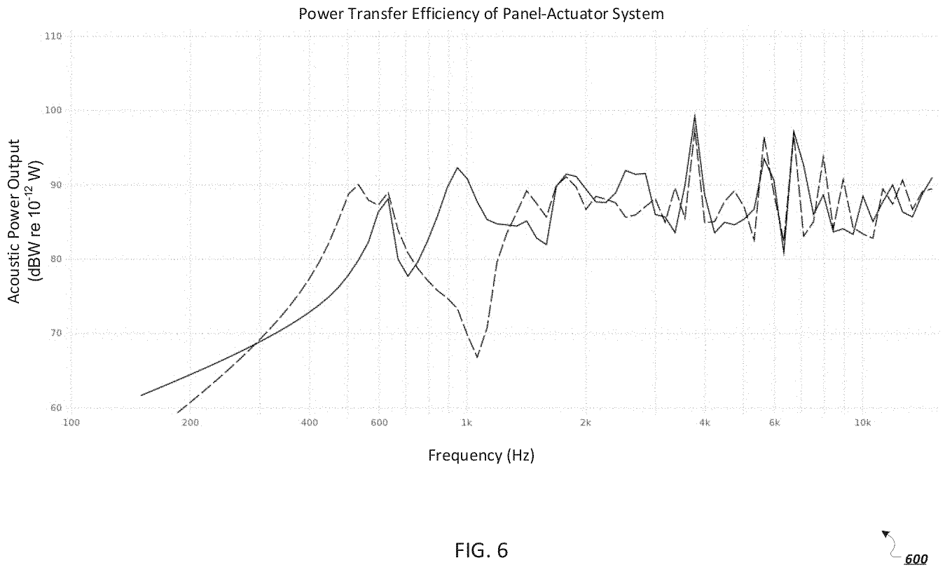

The phase difference can be chosen based on a frequency at which panel 104 is vibrating and the symmetry of the mode of vibration. For example, an even mode of vibration is one in which the panel-actuator system is in phase when electronic control module 220 drives actuators 210 and 212 with signals that are in phase, while an odd mode of vibration, is one in which the panel-actuator system would be out of phase if the electronic control module drove the actuators with signals that are in phase. As described in greater detail below with regard to FIG. 6, a first mode of panel 104 occurs at approximately 500 Hz. The first mode is an even mode, so electronic control module 220 drives actuators 210 and 212 with an in phase signal. A second mode of panel 104 occurs at approximately 900 Hz. The second mode is an odd mode; therefore, electronic control module 220 drives actuators 210 and 212 with signals that are out of phase by 180 degrees or less.

The phase shift between driving signals at each frequency or range of frequencies can be established in a variety of ways. For example, in some implementations, electronic control module 220 can use a formula to determine the appropriate phase difference to apply to the actuators such that each actuator is in phase with panel 104. For example, the formula can take as input, the desired frequency of audio response to be produced by panel 104, and output an appropriate phase difference.

In some implementations, electronic control module 220 can maintain a lookup table that assigns a phase difference between the signals to a corresponding frequency range of the panel audio response. Given a desired frequency of audio response to be produced by panel 104, electronic control module 220 can retrieve the appropriate phase difference using the lookup table, then apply the retrieved phase difference to the driving signals output to actuators 210 and 212. The lookup table can be stored in a memory module of electronic control module 220.

Electronic control module 220 can use other factors, in addition to the desired frequency of audio response, to determine the appropriate phase difference. For example, electronic control module 220 can use a desired sound pressure level of the audio response of panel 104 to determine the appropriate phase difference. As another example, electronic control module 220 can determine the appropriate phase difference based on a mode of mobile device 100. Modes of mobile device 100 can include an audio receiving mode, a music output mode, or a video output mode.

In addition, or alternatively, to changing the phase of the driving signals, electronic control module 220 can vary the amplitude of a first actuator driving signal relative to the amplitude of a second actuator driving signal, e.g., according to the frequency of the audio response. Electronic control module 220 can also vary other qualities of the driving signals, such as the frequency of the signals.

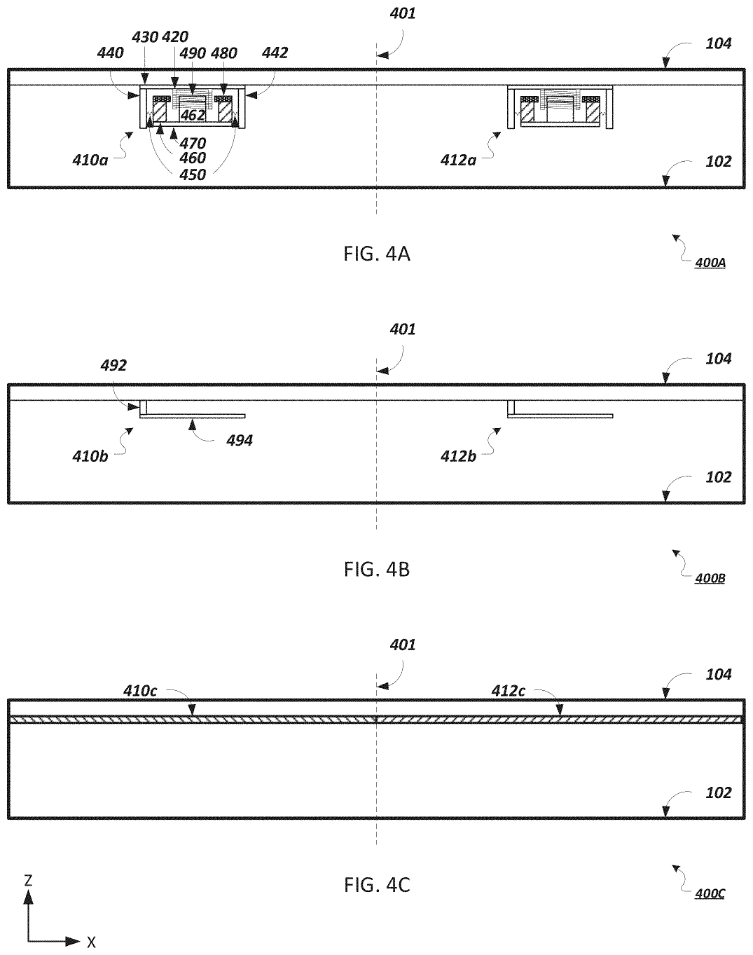

Each actuator 210 and 212 can be one of a variety of different actuator types, so long as the actuators are able to induce a vibration in panel 104. Referring to FIGS. 4A-4C, cross-sections 400A-400C show three mobile devices each including actuators of a different type.

Referring to FIG. 4A, a cross-section of a mobile device 400A includes two electromagnetic (EM) actuators 410a and 412a. EM actuators 410a and 412a each include the same components. Although, so long as the actuators are able to induce a vibration in panel 104, they need not include the same components. While the following discussion describes the components of EM actuator 410a, the discussion also applies to corresponding components of EM actuator 412a.

Actuator 410a includes a magnetic coil 420 attached to a coupling plate 430, which is in turn attached to panel 104. Coupling plate 430 is also attached to posts 440 and 442 that suspend a magnet assembly by compressive elements 450. For example, compressive elements 450 can be springs, such that the magnet assembly can move in the Z-direction.

The magnet assembly includes a back plate 460. The magnet assembly also includes a first magnet 460 and a second magnet 462, which are both attached to back plate 470. First magnet 460 is a pole magnet, while second magnet 462 is a ring magnet, e.g., one that is o-shaped when viewed in the xy-plane. A pole piece 490 is attached to first magnet 460 and is provided to focus the magnetic field generated by first and second magnets 460 and 462 so that the magnetic field passes perpendicular to coil 420, i.e., in the x-direction.

The magnet assembly also includes a front plate 480 which is attached to first magnet 460. Front plate 480 is o-shaped when viewed in the xy-plane. The shape and material properties of front plate 480 are chosen so as to better direct the magnetic field in the x-direction perpendicular to coil 420.

In general, when the magnetic coil is energized, it exerts a force on the magnet assembly, causing the magnet assembly to be displaced in the Z-direction. The force generated by the movement of the magnet assembly is transferred to panel 104, causing the panel to vibrate.

In some embodiments, actuators 210 and 212 are distributed mode actuators (DMAs). For example, referring to FIG. 4B, a cross-section of a mobile device 400B includes two DMAs, 410b and 412b. While the following discussion describes the components of DMA 410b, the discussion also applies to corresponding components of DMA 412b. DMAs 410b and 412b each include an inertial beam 494 that is connected to panel 104 by a stub 492. Vibrational modes are excited in the inertial beam and the resulting force generated by the vibration of the beam is transferred to panel 104, causing the panel to vibrate. DMAs 410b and 412b can be one of a variety of DMA types, e.g., a piezoelectric (PZT) DMA or an electromagnetic (EM) DMA.

Another type of actuator that can be used to induce vibrations in panel 104 is a direct-drive piezoelectric actuator. Referring to FIG. 4C, a cross section 400C includes two piezoelectric (PZT) actuators 410c and 412c. Unlike a piezoelectric DMA, which includes a stub that transfers the vibrations generated by a piezoelectric material to panel 104, a direct-drive PZT actuator includes layers of piezoelectric material coupled directly to the panel. For example, the piezoelectric material can be deposited or bonded directly onto a surface of the panel. When the piezoelectric layers of PZT actuators 410c and 412c are energized, they deform generating a force that is transferred to panel 104. The transferred force causes panel 104 to vibrate.

While FIGS. 4A through 4C show mobile devices having two actuators, a mobile device can have more than two actuators.

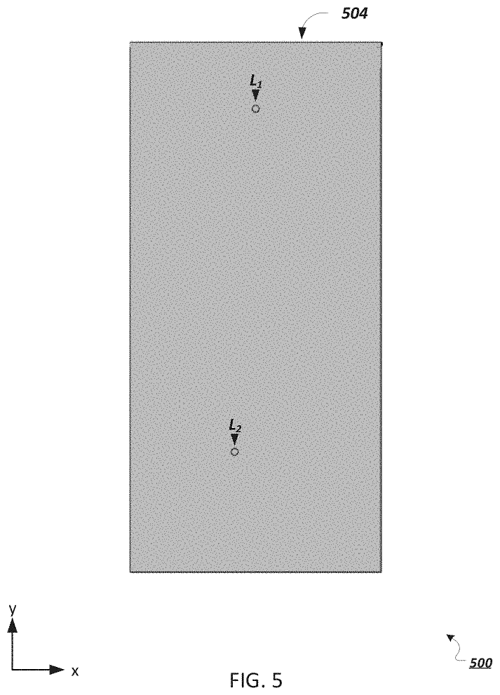

Referring to FIGS. 4A through 4C, the placement of the actuators are approximately symmetric about an axis 401 that runs in the Z-direction. In other implementations, the actuators need not be placed symmetrically. For example, referring to FIG. 5, a top view 500 of a panel 504 shows locations on the panel where an actuator 510 and an actuator 512 are placed. Panel 504 has a width measured in the X-direction, a height measured in the Y-direction, and a depth measured in the Z-direction. Panel 104 can have a height of approximately 14 to 16 cm (e.g., 15.5 cm), a width of approximately 6.5 to 8.5 cm (e.g., 7.5 cm), and a depth of approximately 0.08 to 0.11 cm (e.g., 0.1 cm).

In the example of FIG. 5, actuators 510 and 512 are attached to panel 104 at locations L₁ and L₂, respectively. A vertical axis of symmetry of panel 504 runs parallel to the Y-direction. Location L₁ is approximately in line with the vertical axis of symmetry, while location L₂ is slightly removed from the vertical axis of symmetry. The positions of L₁ and L₂ are determined using quantitative measurements of power transfer. While the example of FIG. 5 shows two possible locations of actuators 510 and 512, other locations are possible, so long as the actuators are able to exert vibrational force on panel 504.

FIG. 6 shows a graph 600 of power transfer efficiency for a simulated device e.g., one such as device 400A. A constant force source was used to simulate two actuators, one placed at location L₁ and the other placed at location L₂. The horizontal axis of graph 600 shows acoustic power output by panel 504 (measured in dBW) versus audio frequency response of the panel (measured in Hz). The solid line denotes acoustic power when the driving signals supplied to actuators 510 and 512 are in phase, while the dashed line denotes the acoustic power output when the driving signals are 180 degrees out of phase.

Graph 600 shows that, in the frequency range of about 300 Hz to about 800 Hz (e.g., from about 300 Hz to about 750 Hz), the acoustic power output is increased when the actuator driving signals are shifted by 180 degrees or less (e.g., 180 degrees), relative to the acoustic power output when the driving signals are in phase. Additionally, the power output when the actuators are driven with driving signals shifted by 180 degrees or less (e.g., 180 degrees) is also increased in the range of about 1000 Hz to about 2000 Hz (e.g., about 1300 Hz to about 1800 Hz) relative to when the actuators are driven with driving signals that are in phase in this range. Therefore, phase-shifting the driving signals results in a more efficient power transfer. That is, the acoustic output of a device can be increased by phase-shifting the device driving signals, without having to increase the magnitude of the driving signal.

Electronic control module 220 can detect when the desired audio frequency response of panel 104 falls within one of the decreased power output ranges, i.e., one of the ranges in which in-phase driving signals lead to inefficient power transfer. Following this detection, electronic control module 220 can phase-shift the driving signals to ensure increased acoustic power output in these ranges. When the desired audio frequency response of panel 104 is not within one of the decreased power output ranges, electronic control module 220 can drive actuators 510 and 512 using in-phase signals. As long as the resulting actuator driving signals are phase-shifted, electronic control module 220 can use any method of phase-shifting, e.g., using a digital filter.

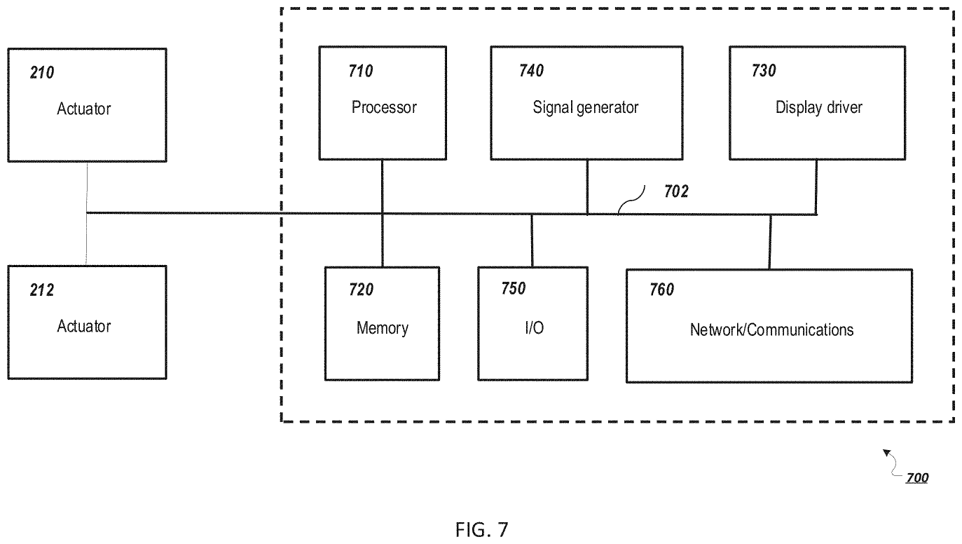

In general, the disclosed actuators are controlled by an electronic control module, e.g., electronic control module 220 in FIG. 2, as described above. In general, electronic control modules are composed of one or more electronic components that receive input from one or more sensors and/or signal receivers of the mobile phone, process the input, and generate and deliver signal waveforms that cause actuators 210 and 212 to provide a suitable haptic response. Referring to FIG. 7, an exemplary electronic control module 700 of a mobile device, such as mobile phone 100, includes a processor 710, memory 720, a display driver 730, a signal generator 740, an input/output (I/O) module 750, and a network/communications module 760. These components are in electrical communication with one another (e.g., via a signal bus) and with actuators 210 and 212.

Processor 710 may be implemented as any electronic device capable of processing, receiving, or transmitting data or instructions. For example, processor 710 can be a microprocessor, a central processing unit (CPU), an application-specific integrated circuit (ASIC), a digital signal processor (DSP), or combinations of such devices.

Memory 720 has various instructions, computer programs or other data stored thereon. The instructions or computer programs may be configured to perform one or more of the operations or functions described with respect to the mobile device. For example, the instructions may be configured to control or coordinate the operation of the device's display via display driver 730, signal generator 740, one or more components of I/O module 750, one or more communication channels accessible via network/communications module 760, one or more sensors (e.g., biometric sensors, temperature sensors, accelerometers, optical sensors, barometric sensors, moisture sensors and so on), and/or actuators 210 and 212.

Signal generator 740 is configured to produce AC waveforms of varying amplitudes, frequency, and/or pulse profiles suitable for actuators 210 and 212 and producing acoustic and/or haptic responses via the actuator. Although depicted as a separate component, in some embodiments, signal generator 740 can be part of processor 710. In some embodiments, signal generator 740 can include an amplifier, e.g., as an integral or separate component thereof.

Memory 720 can store electronic data that can be used by the mobile device. For example, memory 720 can store electrical data or content such as, for example, audio and video files, documents and applications, device settings and user preferences, timing and control signals or data for the various modules, data structures or databases, and so on. Memory 720 may also store instructions for recreating the various types of waveforms that may be used by signal generator 740 to generate signals for actuators 210 and 212. For example, memory 720 can store a lookup table or a formula for determining an appropriate phase shift for an actuator driving signal. Memory 720 may be any type of memory such as, for example, random access memory, read-only memory, Flash memory, removable memory, or other types of storage elements, or combinations of such devices.

As briefly discussed above, electronic control module 700 may include various input and output components represented in FIG. 7 as I/O module 750. Although the components of I/O module 750 are represented as a single item in FIG. 7, the mobile device may include a number of different input components, including buttons, microphones, switches, and dials for accepting user input. In some embodiments, the components of I/O module 750 may include one or more touch sensor and/or force sensors. For example, the mobile device's display may include one or more touch sensors and/or one or more force sensors that enable a user to provide input to the mobile device.

Each of the components of I/O module 750 may include specialized circuitry for generating signals or data. In some cases, the components may produce or provide feedback for application-specific input that corresponds to a prompt or user interface object presented on the display.

As noted above, network/communications module 760 includes one or more communication channels. These communication channels can include one or more wireless interfaces that provide communications between processor 710 and an external device or other electronic device. In general, the communication channels may be configured to transmit and receive data and/or signals that may be interpreted by instructions executed on processor 710. In some cases, the external device is part of an external communication network that is configured to exchange data with other devices. Generally, the wireless interface may include, without limitation, radio frequency, optical, acoustic, and/or magnetic signals and may be configured to operate over a wireless interface or protocol. Example wireless interfaces include radio frequency cellular interfaces, fiber optic interfaces, acoustic interfaces, Bluetooth interfaces, Near Field Communication interfaces, infrared interfaces, USB interfaces, Wi-Fi interfaces, TCP/IP interfaces, network communications interfaces, or any conventional communication interfaces.

In some implementations, one or more of the communication channels of network/communications module 760 may include a wireless communication channel between the mobile device and another device, such as another mobile phone, tablet, computer, or the like. In some cases, output, audio output, haptic output or visual display elements may be transmitted directly to the other device for output. For example, an audible alert or visual warning may be transmitted from the electronic device 100 to a mobile phone for output on that device and vice versa. Similarly, the network/communications module 760 may be configured to receive input provided on another device to control the mobile device. For example, an audible alert, visual notification, or haptic alert (or instructions therefore) may be transmitted from the external device to the mobile device for presentation.

The actuator technology disclosed herein can be used in panel audio systems, e.g., designed to provide acoustic and/or haptic feedback. The panel may be a display system, for example based on OLED of LCD technology. The panel may be part of a smartphone, tablet computer, or wearable devices (e.g., smartwatch or head-mounted device, such as smart glasses).

Other embodiments are in the following claims.

1. A panel audio loudspeaker, comprising:
a panel;
a first actuator attached to the panel at a first location and configured to vibrate the panel at the first location based on a first signal having a first frequency, a first phase, and a first amplitude;
a second actuator attached to the panel at a second location different from the first location, the second actuator being configured to vibrate the panel at the second location based on a second signal having a second frequency, a second phase, and a second amplitude;
an electronic control module in communication with the first and second actuators, the electronic control module being programmed to provide the first and second signals to the first and second actuators,
wherein during operation the vibrations from the first and second actuators cause the panel to generate an audio response and the electronic control module varies the first phase relative to the second phase according to a frequency of the audio response.

2. The panel audio loudspeaker of claim 1, wherein the first and second frequencies are the same.

3. The panel audio loudspeaker of claim 1, wherein the frequency of the audio response is in a range from about 300 Hz to about 800 Hz and a phase difference between the first and second signals is 180 degrees or less.

4. The panel audio loudspeaker of claim 1, wherein the frequency of the audio response is in a range from about 1,000 Hz to about 2,000 Hz and a phase difference between the first and second signals is 180 degrees or more.

5. The panel audio loudspeaker of claim 1, wherein at least one of the first and second actuators is an electromagnetic actuator.

6. The panel audio loudspeaker of claim 1, wherein at least one of the first and second actuators is a distributed mode actuator.

7. The panel audio loudspeaker of claim 1, wherein at least one of the first and second actuators is a direct drive piezoelectric actuator.

8. The panel audio loudspeaker of claim 1, further comprising at least one additional actuator attached to the panel at a location different from the first and second locations and configured to vibrate the panel at the attachment location based on a corresponding signal having a corresponding frequency, a corresponding phase, and a corresponding amplitude, and the electronic control module is programmed to provide the at least one additional actuator with the corresponding signal and to vary the phase of the corresponding signal with respect to the first and second phases according to the frequency of the audio response.

9. The panel audio loudspeaker of claim 1, wherein during operation the electronic control module varies the first amplitude relative to the second amplitude according to the frequency of the audio response.

10. The panel audio loudspeaker of claim 1, wherein an efficiency of the panel audio loudspeaker at the audio frequency is greater for a non-zero phase difference between the first and second signals than when the phase difference is zero.

11. The panel audio loudspeaker of claim 1, wherein the electronic control module comprises a memory module comprising data relating each of a plurality of different frequencies for the audio response to a corresponding phase difference for the first and second signals.

12. The panel audio loudspeaker of claim 1, wherein the panel comprises a display.

13. The panel audio loudspeaker of claim 12, wherein the display is an OLED display.

14. The panel audio loudspeaker of claim 12, wherein the display comprises a touch panel.

15. A method, comprising:
providing a panel audio loudspeaker comprising a panel and first and second actuators attached to the panel at different locations;
driving the panel of the panel audio loudspeaker to provide an audio response by simultaneously driving the first and second actuators with respective first and second signals;
varying a phase difference between the first and second signals according to a frequency of the audio response.

16. The method of claim 15, wherein the phase is varied to increase an efficiency of the panel audio loudspeaker compared to an efficiency of the panel audio loudspeaker when the first and second signals have the same phase.

17. The method of claim 15, further comprising varying a relative amplitude between the first and second signals according to a frequency of the audio response.

18. A mobile device, comprising:
an electronic display panel extending in a plane;
a chassis attached to the electronic display panel and defining a space between a back panel of the chassis and the electronic display panel;
an electronic control module housed in the space, the electronic control module comprising a processor;
a first actuator housed in the space and attached to the electronic display panel at a first location and configured to vibrate the electronic display panel at the first location based on a first signal having a first frequency, a first phase, and a first amplitude; and
a second actuator housed in the space and attached to the electronic display panel at a second location different from the first location, the second actuator being configured to vibrate the electronic display panel at the second location based on a second signal having a second frequency, a second phase, and a second amplitude,
wherein the electronic control module is in electrical communication with the first and second actuators and programmed to activate the first and second actuators during operation of the mobile device to generate an audio response and vary the first phase relative to the second phase according to a frequency of the audio response.
